(19) United States
(12) Patent Application Publication
(10) Pub. No.: US 2019/0187350 A1
(43) Pub. Date: Jun. 20, 2019

(54) POLARIZING ELEMENT

(71) Applicant: SEIKO EPSON CORPORATION, Tokyo (JP)

(72) Inventor: Shunpei YOSHIKAWA, Chino-shi (JP)

(73) Assignee: SEIKO EPSON CORPORATION, Tokyo (JP)

(21) Appl. No.: 16/223,884

(22) Filed: Dec. 18, 2018

(30) Foreign Application Priority Data
Dec. 19, 2017 (JP) 2017-242456

(51) Int. Cl. G02B 5/30

(52) U.S. Cl. CPC G02B 5/3058

(57) ABSTRACT

A polarizing element includes a substrate having light translucency, a grid aligned at predefined intervals in one direction, the grid being formed of metal, and a metal film for covering the grid located in a second region along the outer edge of the substrate, the second region being outside of a first region.

### BACKGROUND

### 1. Technical Field

The present invention relates to a polarizing element.

### 2. Related Art

As described in, for example, JP-A-2015-180975, a method of manufacturing a polarization plate is known in which grids are formed on an underlying film on the entire surface of a wafer substrate, a non-formation region, where no grid is formed, is formed at the circumferential portion of the wafer substrate, and the grids and the non-formation region are covered with a protective film.

According to the method of manufacturing a polarization plate disclosed in JP-A-2015-180975, since the non-formation region, where no grid is formed, is formed in the circumferential portion of a wafer substrate, it is stated that the grids do not deteriorate under a high temperature or high humidity environment even if the protective film for covering the circumferential portion is destroyed. Accordingly, it is stated that a polarization plate having high reliability can be manufactured even under a high temperature or high humidity environment.

Unfortunately, according to the method of manufacturing a polarization plate described in JP-A-2015-180975, the grids and the non-formation region are concurrently formed, and thus, the grids and the non-formation region need to be formed in accordance with the size of a product (model) to which the polarization plate is applied. In other words, individual product management is required at the stage of forming the grids, and thus, the process commonality among the products in manufacturing the polarization plate as a component is hampered, making it difficult to improve productivity.

### SUMMARY

The invention has been made to address at least some of the above-described issues and can be realized as the following exemplary embodiments or application examples.

### APPLICATION EXAMPLE 1

A polarizing element according to the application example includes a substrate having light translucency, a grid aligned at predefined intervals in one direction on one surface of the substrate, the grid being formed of metal, and a metal film that covers the grid formed in a second region along an outer edge of the substrate, the second region being outside of a first region on one surface.

A failure mode caused by deterioration of a grid made of metal in a high temperature or high humidity environment is hereinafter referred to as corrosion. According to the application example, it takes some time until corrosion advances to reach the first region as an effective region due to the metal film that covers the grid, which serves as a starting point of corrosion in the second region. Accordingly, a metal film provided in an amount sufficient to impregnate the progress of a corrosion reaction in the second region located outside of the first region can cause a significant delay of the corrosion of the grid. In addition, the grid formed in the second region promotes process commonality among products in manufacturing the polarizing element, compared to the case where the non-formation region is formed concurrently as the grid as in JP-A-2015-180975 described above. Accordingly, a polarizing element capable of improving corrosion resistance and achieving high productivity can be provided.

### APPLICATION EXAMPLE 2

The polarizing element described in the above application example may include an oxide film that covers the grid.

According to the application example, coverage of the grid with the oxide film further prevents a causative substance of the corrosion from reaching the grid. This further improves the corrosion resistance.

### APPLICATION EXAMPLE 3

In the polarizing element described in the above application example, the metal film may be provided to fill a gap of the grid in the second region.

According to the application example, filling a gap of the grid with the metal film makes it possible to provide a number of metal atoms to be consumed in a corrosion reaction, ensuring a delay of the corrosion of the grid as a result.

### APPLICATION EXAMPLE 4

In the polarizing element described in the above application example, the metal film may be formed of a metal having higher ionization tendency than the grid.

According to the application example, the provision of the metal film having higher ionization tendency than the grid makes the metal film to be preferentially corroded compared to the grid, enabling the corrosion of the grid to be delayed.

### APPLICATION EXAMPLE 5

The polarizing element described in the above application example may include a protective film that covers the grid in the first region and covers the metal film in the second region.

According to the application example, the application of the protective film to the grid in the first region as well makes it possible to impart a corrosion resistance to a region other than the second region.

### APPLICATION EXAMPLE 6

In the polarizing element described in the above application example, the protective film may be formed of an inorganic film having light translucency.

According to the application example, the formation of the inorganic film having light translucency as the protective film in the first region, in addition to reducing deterioration of optical properties such as reflectance or transmittance of polarized light, makes it possible to provide an effect of preventing the corrosion from advancing to the grid.

### APPLICATION EXAMPLE 7

In the polarizing element described in the above application example, the protective film may be formed of an organic film having water repellency.

According to the application example, the application of the organic film having water repellency as a protective film makes it possible to suppress adhesion of water that mediates causative substances of the corrosion, enabling the corrosion of the grid to be delayed.

### APPLICATION EXAMPLE 8

In the polarizing element described in the above application example, the protective film may include an inorganic film having light translucency and an organic film having water repellency overlaid on the inorganic film.

According to the application example, the inorganic film and the organic film that are stacked together prevent both progress of corrosion of the grid and adhesion of water, providing a further corrosion delaying effect.

### APPLICATION EXAMPLE 9

In the polarizing element described in the above application example, the grid may include a fine line portion aligned in the one direction and an absorption layer having light absorbency provided on a top portion of the fine line portion.

According to the application example, the provision of the absorption layer at the top portion of the fine line portion makes it possible to provide an effect of absorbing polarized light that does not pass through the grid by the absorption layer. In other words, a polarizing element having excellent optical properties can be provided.

### APPLICATION EXAMPLE 10

A method of manufacturing a polarizing element according to the application example, the method including overlaying a first metal film and an absorption layer having light absorbency on one surface of a mother substrate having light translucency to which a plurality of substrates is imposed, collectively patterning the first metal film and the absorption layer to form a grid including a fine line portion aligned in one direction at predefined intervals and the absorption layer, forming a second metal film that covers the grid formed in a second region located outside of a first region of the substrate and along an outer edge of the substrate for each of the plurality of substrates of the mother substrate, and dividing the mother substrate to produce the substrate.

According to the application example, the formation of the second metal film in an amount sufficient to impregnate the progress of a corrosion reaction in the second region can cause a significant delay of the corrosion of the grid. The process from the forming of the first metal film to the forming of the second metal film performed on the mother substrate makes it possible to produce a polarizing element, lowering the manufacturing cost compared to the case of performing the process using a single substrate. In addition, the absorption layer overlaid on the fine line portion allows the polarized light reflected at the fine line portion made of metal to be absorbed by the absorption layer, enabling a polarizing element having excellent optical properties to be manufactured.

### APPLICATION EXAMPLE 11

In the method of manufacturing the polarizing element described in the above application example, the forming of the second metal film includes forming the second metal film by a vapor phase growth method using a mask disposed opposite to the mother substrate, the mask including an opening corresponding to the second region.

According to the application example, the second metal film is formed by a vapor phase growth method through a mask on the mother substrate, preventing damage to the grid compared to the case of masking the mother substrate with a resist.

### APPLICATION EXAMPLE 12

The method of manufacturing the polarizing element described in the above application example may include heating the mother substrate in an atmosphere containing oxygen.

According to the application example, an oxide film can be formed on the grid and the absorption layer by heating the mother substrate in an atmosphere containing oxygen, where the oxide film enables a corrosive substance reaching the grid to be delayed in order to improve the corrosion resistance.

### APPLICATION EXAMPLE 13

In the method of manufacturing the polarizing element described in the above application example, the first metal film and the second metal film may be formed using an identical metal material.

According to the application example, the use of an identical metal material enables the corrosion speeds of the first metal film and the second metal film to be equalized, preventing the first metal film from being preferentially corroded.

### APPLICATION EXAMPLE 14

In the method of manufacturing the polarizing element described in the above application example, the second metal film may be formed using a metal material having higher ionization tendency than the first metal film.

According to the application example, the formation of the second metal film using a metal material having high ionization tendency allows the second metal film to be preferentially corroded, enabling the corrosion of the first metal film to be delayed.

### APPLICATION EXAMPLE 15

The method of manufacturing the polarizing element described in the above application example may include forming a protective film that covers the grid in the first region and covers the second metal film in the second region before producing the substrate from the mother substrate.

According to the application example, the formation of the protective film before producing the substrate from the mother substrate, in addition to improving the corrosion resistance in a reliable manner by the application of the protective film, makes it possible to reduce the manufacturing processes after the mother substrate is divided, enabling the manufacturing cost to be lowered.

### APPLICATION EXAMPLE 16

In the method of manufacturing the polarizing element described in the above application example, the forming of the protective film may include forming an inorganic film having light translucency.

According to the application example, the formation of the inorganic film having light translucency as the protective film in the first region, in addition to reducing the deterioration of the optical properties such as reflectance or transmittance of polarized light, makes it possible to provide an effect of preventing the corrosion from advancing to the grid.

### APPLICATION EXAMPLE 17

In the method of manufacturing the polarizing element described in the above application example, the forming of the protective film includes forming an organic film having water repellency.

According to the application example, the application of the organic film having water repellency as a protective film makes it possible to suppress adhesion of water that mediates causative substances of the corrosion, enabling the corrosion of the grid to be delayed.

### APPLICATION EXAMPLE 18

The method of manufacturing the polarizing element described in the above application example may include, as the forming of the protective film, forming an inorganic film having light translucency and forming an organic film having water repellency overlaid on the inorganic film.

According to the application example, the inorganic film and the organic film that are stacked together prevent both progress of corrosion of the grid and adhesion of water, providing a further corrosion delaying effect.

### BRIEF DESCRIPTION OF THE DRAWINGS

The invention will be described with reference to the accompanying drawings, wherein like numbers reference like elements.

FIG. 1 is a plan view schematically illustrating a configuration of a polarizing element of Exemplary Embodiment 1.

FIG. 2 is a cross-sectional view schematically illustrating a structure of the polarizing element of Exemplary Embodiment 1.

FIG. 3 is a cross-sectional view schematically illustrating a polarizing element in which an inorganic film according to Exemplary Embodiment 1 is used alone as a protective film.

FIG. 4 is a cross-sectional view schematically illustrating a polarizing element in which an organic film of Exemplary Embodiment 1 is used alone as a protective film.

FIG. 5 is a flowchart illustrating a method of manufacturing the polarizing element of Exemplary Embodiment 1.

FIG. 6 is a cross-sectional view illustrating step S1 of a manufacturing process in FIG. 5.

FIG. 7 is a cross-sectional view illustrating step S2 of the manufacturing process in FIG. 5.

FIG. 8 is a cross-sectional view illustrating resist patterning in step S3 of the manufacturing process in FIG. 5.

FIG. 9 is a cross-sectional view illustrating dry etching in step S3 of the manufacturing process in FIG. 5.

FIG. 10 is a cross-sectional view illustrating step S4 of the manufacturing process in FIG. 5.

FIG. 11 is a plan view illustrating a mother substrate after step S4 of the manufacturing process in FIG. 5.

FIG. 12 is a cross-sectional view illustrating a metal film in step S4 of the manufacturing process in FIG. 5.

FIG. 13 is a cross-sectional view schematically illustrating a structure of a polarizing element of Exemplary Embodiment 2.

FIG. 14 is a cross-sectional view schematically illustrating a polarizing element in which an inorganic film of Exemplary Embodiment 2 is used alone as a protective film.

FIG. 15 is a cross-sectional view schematically illustrating a polarizing element in which an organic film of Exemplary Embodiment 2 is used alone as a protective film.

FIG. 16 is a plan view schematically illustrating a configuration of a polarizing element of Modified Example 1.

### DESCRIPTION OF EXEMPLARY EMBODIMENTS

Exemplary Embodiments of the invention will be described below with reference to the drawings. Note that, in each of the drawings below, to make each layer and each member a recognizable size, each of the layers and each of the members are illustrated to be different from an actual scale and an actual angle.

### Exemplary Embodiment 1

### Polarizing Element

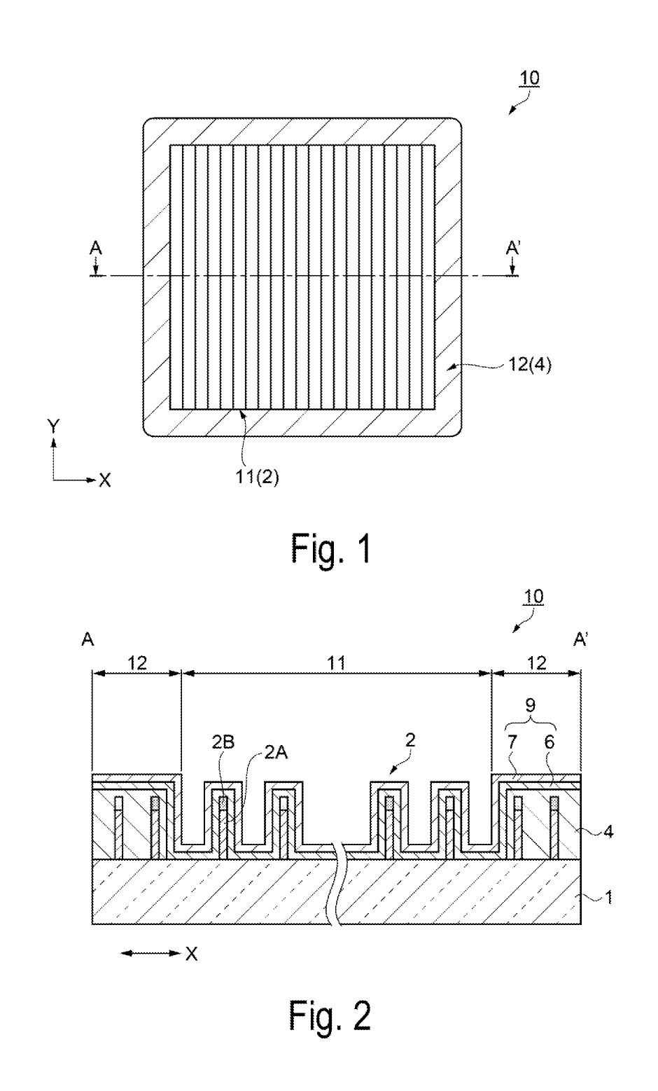

First, a polarizing element of Exemplary Embodiment 1 will be described with reference to FIGS. 1 and 2. FIG. 1 is a plan view schematically illustrating a configuration of a polarizing element of Exemplary Embodiment 1. FIG. 2 is a cross-sectional view schematically illustrating a structure of the polarizing element in FIG. 1 taken along a line A-A′ in FIG. 1.

As illustrated in FIG. 1, a polarizing element 10 of Exemplary Embodiment 1 includes a first region 11 having a quadrilateral shape in a plan view and provided with a plurality of grids 2, and a second region 12 provided with a metal film 4 in a manner surrounding the first region 11. As illustrated in FIG. 2, focusing attention on the cross section of the polarizing element 10, the polarizing element 10 includes a substrate 1 having light translucency, in the first region 11 and the second region 12 of which the plurality of grids 2 is formed on one surface of the substrate 1 in a manner of being aligned at intervals in one direction. In the second region 12, the metal film 4 is provided to cover the plurality of grids 2.

The grid 2 includes a stacked structure in which a fine line portion 2A made of metal processed into a grid shape and an absorption layer 2B having light absorbency provided at the top portion of the fine line portion 2A are stacked together, where a protective film 9 is provided on the surfaces of the grid 2 and the surfaces of the substrate 1 between adjacent grids 2 in the first region 11. In the second region 12 as well, the protective film 9 is provided to cover the surface of the metal film 4 for covering the plurality of grids 2. The protective film 9 of Exemplary Embodiment 1 is formed by stacking an inorganic film 6 having light translucency and an organic film 7 having water repellency together.

The polarizing element 10 is a polarization plate having a so-called wire grid (WG) structure. Hereinafter, each of the portions constituting the polarizing element 10 will be described.

A base material having light translucency such as glass, quartz, plastic, or the like is used for the substrate 1.

The grid 2 represents a structure including the fine line portion 2A employing a plurality of fine line structures obtained by processing a metal thin film along a direction intersecting the one direction above and the absorption layer 2B provided at the top portion of the fine line portion 2A.

The grids 2 are aligned at equivalent intervals with a period shorter than the wavelength of visible light, where the plurality of fine line structures forms a wire grid type polarizing layer both in the first region 11 and in the second region 12. For example, the interval of the grids 2 is approximately 70 nm, the width of the grid 2 ranges from 20 nm to 60 nm, and the height of the grid 2 from the substrate surface ranges from 35 nm to 260 nm. The first region 11 is formed of a reflection type polarizing layer for transmitting linearly polarized light oscillating in a direction orthogonal to the extending direction of the grid 2 and for reflecting linearly polarized light oscillating in the extending direction of the grid 2.

A metal having high light reflectance in the visible light wavelength range may be used as the material of the fine line portion 2A. Specifically, for example, aluminum, silver, copper, chromium, titanium, nickel, tungsten, iron, or the like may be used. In Exemplary Embodiment 1, aluminum is used as the material of the fine line portion 2A.

A metal having a light absorption rate greater than the light absorption rate of the surface of the fine line portion 2A in the visible region, such as silicon, germanium, tantalum, or the like may preferably be used for the absorption layer 2B, and the absorption layer 2B may be formed from an oxide, nitride, or the like of the metal. In Exemplary Embodiment 1, silicon is used as the material of the absorption layer 2B. The provision of the absorption layer 2B at the top portion of the fine line portion 2A allows stray light (linearly polarized light) reflected at the fine line portion 2A to be absorbed in the absorption layer 2B, thus achieving a polarizing element 10 having excellent optical properties.

Hereinafter, descriptions are given where one direction in which the grids 2 are aligned at equivalent intervals is defined as an X direction, while a direction being orthogonal to the X direction and extending in the direction of the grid 2 is defined as a Y direction. The descriptions are also given where viewing of the polarizing element 10 from the protective film 9 side is represented as “planar” or “planarly”.

The inorganic film 6 constituting the protective film 9 may be formed of, as the material, an inorganic compound such as silicon oxide, aluminum oxide, hafnium oxide, or the like. Similarly, the organic film 7 constituting the protective film 9 may be formed of an organic compound exhibiting water repellency after being formed, such as an organic silane type coupling agent represented by R—SiX₃, a phosphonic acid type coupling agent represented by R—PO₃H₂, a carboxylic acid type coupling agent represented by R—COOH, or a thiol type coupling agent represented by R—SH, individually or in combination of a plurality of types. It is herein noted that examples of the R moiety include an alkyl chain having a straight chain or a cyclic ring and an aromatic group, where the structure of the R moiety may be partially substituted with, for the purpose of lowering the surface energy, a fluoroalkyl group, a fluoroalkyl ether group, or the like. Further, examples of the X moiety include a halogen such as F, Cl, Br, I, or the like, and an alkoxy group such as OCH₃, OC₂H₅, OC₃H₇, or the like.

Note that the inorganic film 6 and the organic film 7 that are the protective film 9 formed on the surface of the grid 2 are provided for the purpose of enhancing corrosion resistance of the grid 2 in the first region 11, where the inorganic film 6 or the organic film 7 may be used alone for imparting the corrosion resistance.

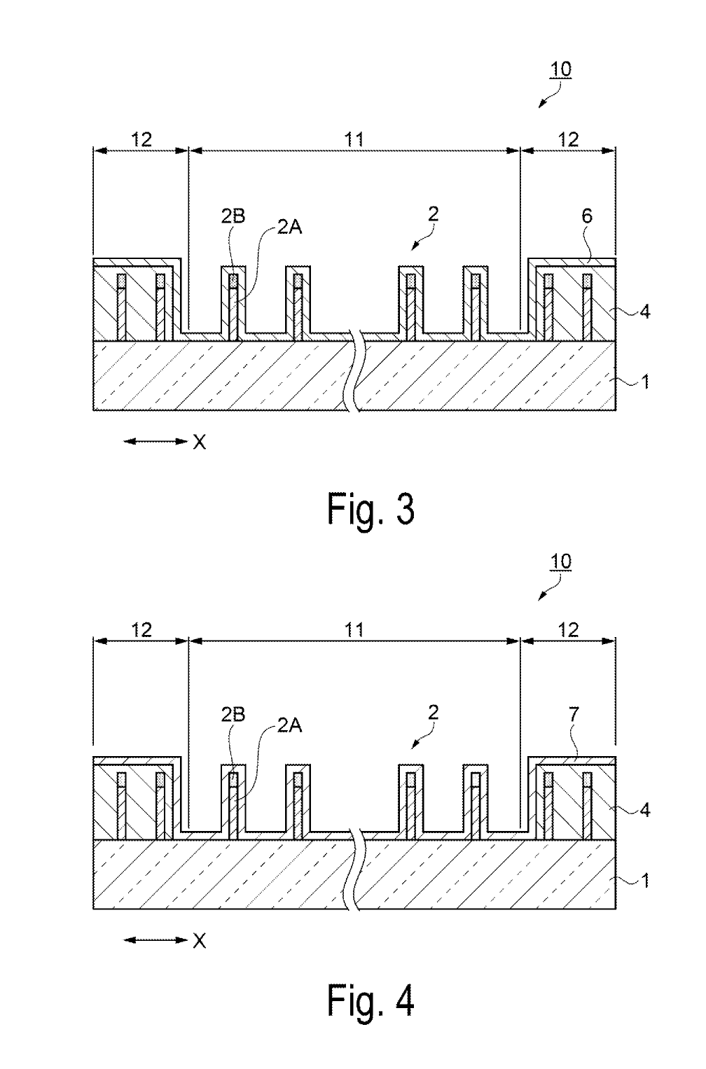

FIGS. 3 and 4 are cross-sectional views schematically illustrating other configuration examples of the protective film 9. Specifically, the protective film 9 may include a combination in which the inorganic film 6 having light translucency is applied alone to the grid 2 as illustrated in FIG. 3, or a combination in which the organic film 7 having water repellency is applied alone to the grid 2 as illustrated in FIG. 4.

A material that is similar to the material formed on the surface of the grid 2 in the first region 11 can be used for the inorganic film 6 and the organic film 7 constituting the protective film 9 for covering the metal film 4 in the second region 12.

Turning back to FIG. 2, the second region 12 includes a structure in which the metal film 4 is formed over the whole periphery of the polarizing element 10, where the protective film 9 (the inorganic film 6 and the organic film 7) is formed on the surface of the metal film 4 as well. As described above, the protective film 9 may be formed of the inorganic film 6 alone or the organic film 7 alone, while the protection film 9 having further enhanced corrosion resistance can be formed by the organic film 7 having water repellency overlaid on the inorganic film 6.

In Exemplary Embodiment 1, the fine line portion 2A is formed using aluminum, and the absorption layer 2B located at the top portion of the fine line portion 2A is formed using silicon. The metal film 4 is formed using aluminum. The metal film 4 is formed using an identical material as the fine line portion 2A but may preferably be formed using a material having an ionization tendency higher than the fine line portion 2A, for example, magnesium (Mg). The use of a material having an ionization tendency higher than the fine line portion 2A as the material of the metal film 4 allows the metal film 4 to be preferentially corroded, causing a delay of the corrosion of the grid 2 (the fine line portion 2A). That is, the metal film 4 provided in the second region 12 serves as a sacrificial film for delaying the corrosion of the grid 2 provided in the first region 11.

Thus, the polarizing element 10 including the metal film 4 as the sacrificial film in the second region 12 along the outer edge of the substrate 1 is produced in practice using a mother substrate. Although a detailed method of manufacturing the polarizing element 10 will be described below, it is noted that the protective film 9 is not provided on the side surfaces at the outer edge of the polarizing element 10 illustrated in FIG. 2, where the side surfaces corresponds to division surfaces formed when the polarizing element 10 is produced by dividing the mother substrate. Nonetheless, in a case of manufacturing the polarizing element 10 one by one, the protective film 9 may also be provided on the side surfaces of the outer edge of the polarizing element 10, which is rather favorable in view of enhancing the corrosion resistance.

Regarding the dimensions of the metal film 4, the volume of the metal film 4 in the second region 12 may preferably be as large as possible for the sake of exerting a function as the sacrificial film, but the first region 11 as an effective region may become too small when the width is made excessively wide. On the other hand, if the width of the second region 12 where the metal film 4 is to be provided is made wide in the X direction or in the Y direction, the number of polarizing elements 10 produced from the mother substrate may be lower. In addition, if cracks or the like occur on the outer edge of the polarizing element 10 when the polarizing element 10 is produced by dividing the mother substrate, corrosion may proceed from the portion where the cracks occurred. Accordingly, in Exemplary Embodiment 1, the width of the second region 12 is set to at least 0.2 mm in consideration of dividing the mother substrate, and the film thickness of the metal film 4 in the second region 12 is set to 35 nm or greater than that of the grid 2.

Note that the metal film 4 is illustrated in FIG. 2 to cover two grids 2 in the second region 12, but in reality, as described above, the interval of the grid 2 in the X direction is as large as 70 nm and the width of the grid 2 in the X direction ranges from 20 nm to 60 nm. Thus, the metal film 4 covers multiple grids 2.

Although the method of manufacturing the polarizing element 10 will be described in detail below, the metal film 4 may be formed by a vapor phase growth method performed on the mother substrate by using a mask, and the formation range depends on the design of the mask. Thus, a polarizing element 10 of any size can be readily fabricated on the mother substrate by only changing the mask, promoting process commonality among the products in manufacturing the polarizing element 10 as a product. As such, according to Exemplary Embodiment 1, the polarizing element 10 of any size for guaranteeing corrosion resistance can be provided.

Method of Manufacturing Polarizing Element

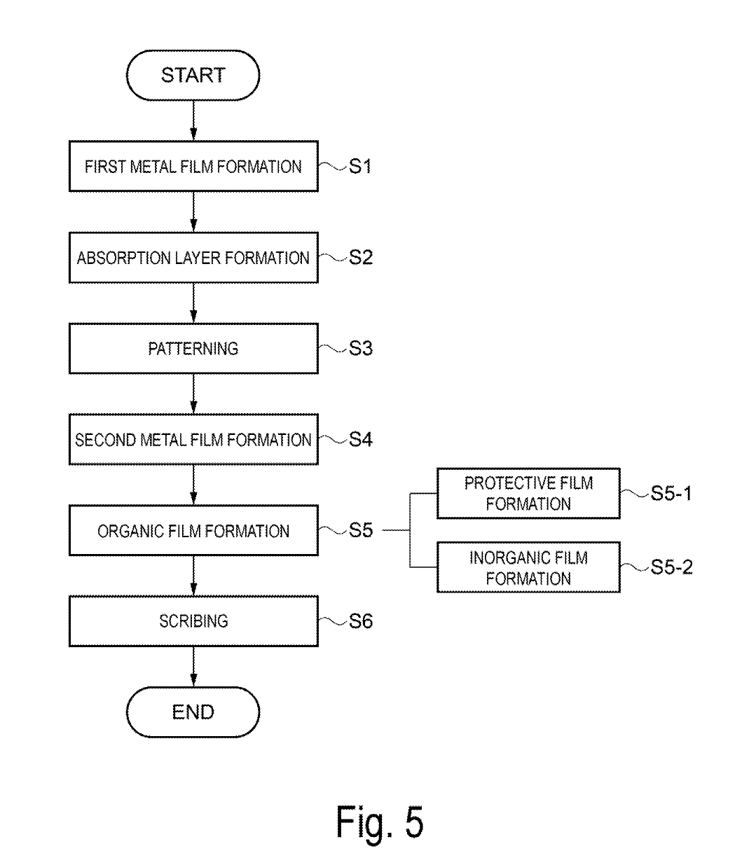

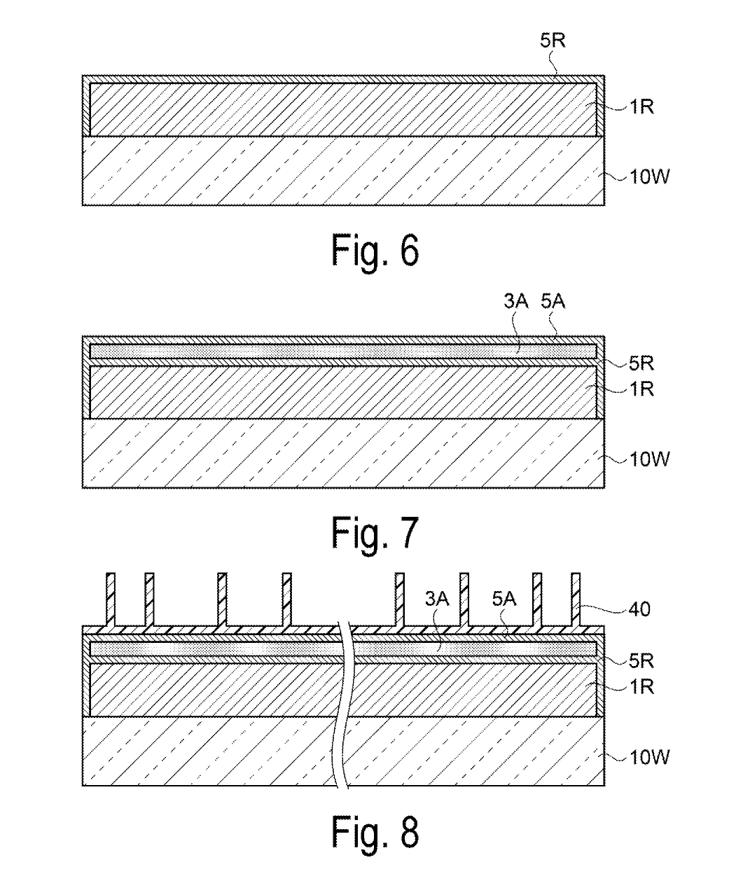

Next, a method of manufacturing the polarizing element 10 of Exemplary Embodiment 1 will be described with reference to FIGS. 5 to 12. FIG. 5 is a flowchart illustrating a method of manufacturing a polarizing element of Exemplary Embodiment 1. FIGS. 6 to 12 are cross-sectional views schematically illustrating the steps of the manufacturing process for a polarizing element of Exemplary Embodiment 1. Note that FIGS. 6 to 12 correspond to the structure of the polarizing element 10 taken along the line A-A ‘illustrated in FIG. 2, or to the cross-sectional view schematically illustrating a status of the mother substrate.

As illustrated in FIG. 5, the method of manufacturing the polarizing element 10 of Exemplary Embodiment 1 includes a step of forming a first metal film (step S1), a step of forming the absorption layer (step S2), a step of collectively patterning the first metal film and the absorption layer (step S3), a step of forming a second metal film in the second region 12 (step S4), a step of forming the protective film (step S5) and a scribing step of producing the substrate 1 (the polarizing element 10) from a mother substrate 10W (step S6). The step of forming the protective film (step S5) includes a step of forming an inorganic film having light translucency across the first region 11 and the second region 12 (step S5-1) and a step of forming an organic film having water repellency across the first region 11 and the second region 12 (step S5-2).

For an orderly explanation of each of the steps in FIG. 5, each step of steps S1 to S6 uses the mother substrate 10W to which a plurality of substrates 1 is imposed.

In the step of forming the first metal film in step S1, as illustrated in FIG. 6, a first metal film 1R and a dielectric layer 5R on a surface of the first metal film 1R are formed on one surface side of the mother substrate 10W (the substrate 1) and subsequently in step S2, as illustrated in FIG. 7, an absorption layer 3A is formed overlaying on the first metal film 1R. More specifically, in step S1, first, the first metal film 1R is formed. In Exemplary Embodiment 1, the first metal film 1R formed of aluminum is formed by a sputtering method using a target made of, for example, aluminum. The thickness of the first metal film 1R thus formed is approximately 240 nm. Thereafter, the mother substrate 10W is taken out to the atmosphere and the surface of the mother substrate is cleaned with pure water or the like, then, the dielectric layer 5R (aluminum oxide) obtained by natural oxidation of the first metal film 1R (aluminum) can be formed, removing the particles generated at the time of film formation. By forming the dielectric layer 5R as a natural oxide film on the surface of the first metal film 1R, mutual diffusion with the material of the absorption layer 3A to be subsequently formed and lowering of the optical properties can be suppressed.

Next, in step S2, the absorption layer 3A formed of silicon is formed by, for example, a sputtering method using a silicon target. The thickness of the absorption layer 3A thus formed ranges approximately from 5 nm to 100 nm. Thereafter, the mother substrate 10W taken out from an apparatus to proceed to the next step S3 is exposed to the atmosphere, and then a dielectric layer 5A (silicon oxide) as a natural oxide film is formed on the surface of the absorption layer 3A (silicon).

Next, in step S3, resist patterning for forming a wire grid structure and dry etching are performed to collectively pattern the first metal film 1R and the absorption layer 3A. First, a resist 40 is applied by a spin coating method or the like to make the film thickness uniform, and then patterning is performed in accordance with the wire grid structure.

Although in Exemplary Embodiment 1, the patterning is performed using photocurable nanoimprint lithography to obtain a resist pattern structure in which a portion corresponding to a grid is formed in a convex shape as illustrated in FIG. 8, the patterning may also be performed using thermocurable nanoimprint lithography, a two-luminous flux interference exposure method, argon fluoride (ArF) excimer laser as exposure light, or the like. Thereafter, etching is performed through the resist 40 to form the wire grid structure.

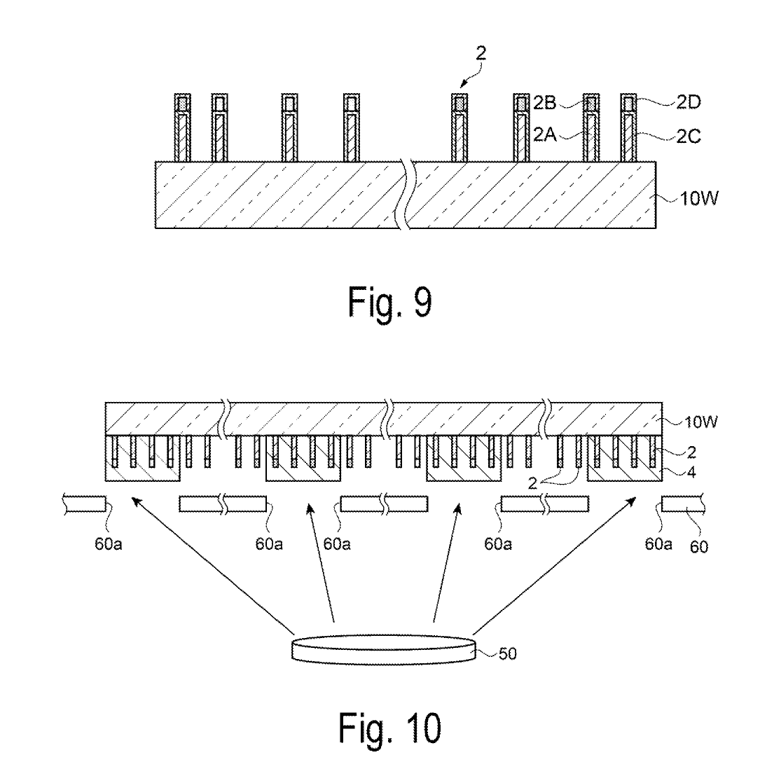

In the etching step described above, the absorption layer 3A may be etched by, for example, a dry etching treatment using a fluorine-based etching gas (e.g., CF₄, CHF₃, CH₂F₂, and C₄F₈). Meanwhile, the first metal film 1R can be etched by, for example, a dry etching treatment using a chlorine-based etching gas (Cl₂, BCl₃, or the like). Specifically, a part of the gas exemplified above and an inert gas such as Ar or N₂ are mixed together to form a plasma, and then the dry etching treatment is performed. Thereafter, an asking treatment using O₂ plasma, or washing with pure water, alcohols, ozone water, oxalic acid agent, phosphoric acid type agent, ammonium type agent, hydrofluoric acid type agent, or the like is performed to remove resist residue and ion components such as Cl and F remaining after the dry etching. Thus, the wire grid structure illustrated in FIG. 9 is formed. Specifically, the grid 2 includes the fine line portion 2A formed of aluminum and the absorption layer 2B formed at the top portion of the fine line portion 2A, where, on the side surfaces of the fine line portion 2A, is formed a dielectric layer 2C (aluminum oxide) as a natural oxide film and, on the surface of the absorption layer 2B, is formed a dielectric layer 2D (silicon oxide) as a natural oxide film.

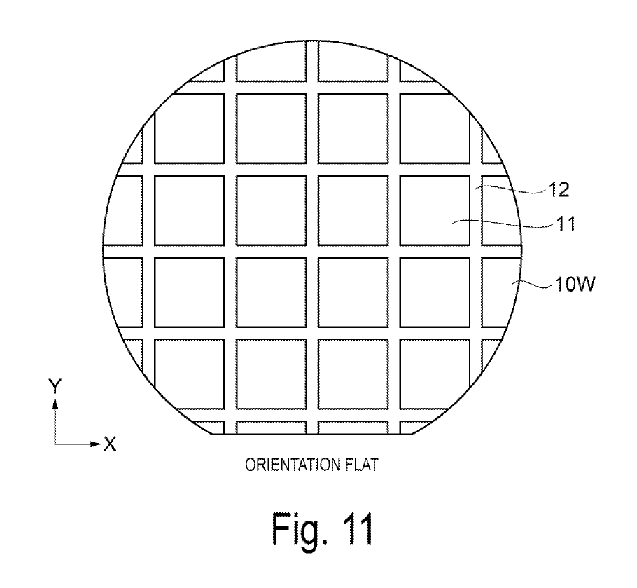

Next, in step S4, the metal film 4 as the second metal film is formed by a vapor growth method. In Exemplary Embodiment 1, a sputtering method using a mask 60 as illustrated in FIG. 10 was utilized. The metal film 4 is formed at a position corresponding to an opening 60a of the mask 60 in a state where the mask 60 is disposed between the mother substrate 10W and a target 50. The film thickness of the metal film 4 is designed to be thicker than the height of the grid 2 on the mother substrate 10W. Thus, the gap between adjacent grids 2 is filled with the metal film 4, and as illustrated in FIG. 11, the second region 12 on which the metal film 4 is formed, is formed extending in the X direction and in the Y direction to surround each first region 11 as the effective region in each substrate 1 with reference to the orientation flat of the mother substrate 10W, thus forming the mother substrate 10W in a lattice shape. Note that the mask 60 is a hard mask formed using invar or the like.

Although in Exemplary Embodiment 1, aluminum is used as the target 50, the metal film 4 may also be formed using a target made of a material different from the material of the grid 2 such as magnesium having higher ionization tendency than the material (aluminum) of the grid 2 for the purpose of delaying or preventing corrosion of the grid 2 as described above.

Further, in Exemplary Embodiment 1, the mask 60 is disposed between the mother substrate 10W and the target 50, where the mask 60 avoids a direct contact with the mother substrate 10W. This is desirable in terms of preventing physical damage such as collapsing of the grid 2 due to a contact of the mask 60 as well as in terms of improving production yield. Note that a partial region or the entire region of the mask 60 may be in contact with the mother substrate 10W.

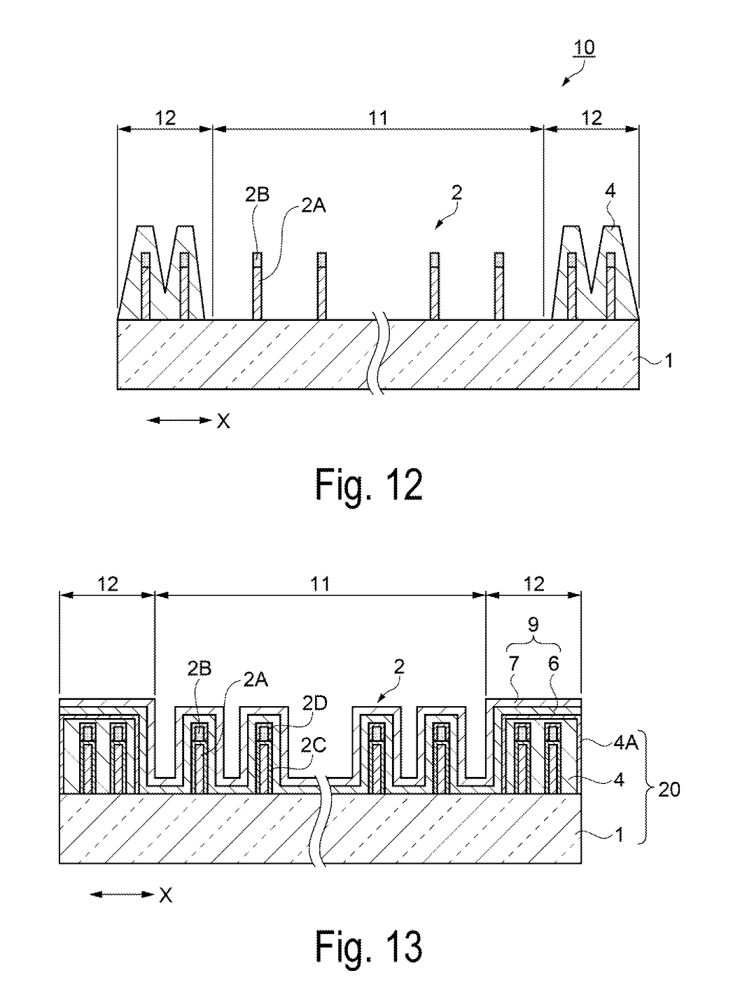

Since the range in which the metal film 4 is formed (corresponding to the second region 12) varies depending on the dimension of the opening 60a of the mask 60, the polarizing element 10 of any size can be readily formed on the mother substrate 10W by only changing the mask 60, promoting process commonality among the products in manufacturing the polarizing element 10 as a product. Further, although the film thickness of the metal film 4 may be not less than the height at which the grid 2 residing in the second region 12 is wholly filled, the film thickness may also be as large as a film thickness at which the grid 2 is covered with the metal film 4, as illustrated in FIG. 12.

Next, in step S5, the protective film 9 is formed. In step S5, as illustrated in FIG. 5, both step S5-1 for forming the inorganic film 6 and step S5-2 for forming the organic film 7 are performed. In step S5-1, as illustrated in FIG. 3, the inorganic film 6 is formed across the first region 11 and the second region 12 on the substrate 1, and subsequently in step S5-2, as illustrated in FIG. 2, the organic film 7 is formed overlaid on the inorganic film 6.

Although in Exemplary Embodiment 1, the organic film 7 is formed in step S5-2 after the inorganic film 6 is formed in step S5-1, either the inorganic film 6 or the organic film 7 may be formed as the protective film 9 like in either step S5-1 alone or step S5-2 alone. Further, the protective film 9 of two or more layers may be formed with the inorganic film 6 and the organic film 7 in combination by repeating step S5-1 and step S5-2 in combination. Note that the step of forming either one of the inorganic film 6 and the organic film 7 or the step of forming the protective film 9 of two or more layers including the inorganic film 6 and the organic film 7 may be performed between step S3 and step S4, by which the protective film 9 is formed in advance on the grid 2 alone at a stage before the formation of the metal film 4.

A vapor phase growth method such as a sputtering method, CVD method, ALD method, or vapor deposition method may be used to form the inorganic film 6 in step S5-1. Further, in the formation of the organic film 7 in step S-2, the organic film 7 may be chemically bonded to or may be formed on the surface on which the film is to be formed using, for example, a liquid phase method in which the mother substrate 10W is immersed in a solution obtained by diluting the coupling agent noted above with an organic solvent to carry out annealing, or a vapor phase method in which the film is formed by vaporizing the coupling agent noted above by means of heating or pressure reduction in a sealed space together with the mother substrate 10W.

Although in Exemplary Embodiment 1, a silicon oxide is formed by a sputtering method in step S5-1 and a silane coupling agent is formed by a gas phase method in step S5-2, the inorganic film 6 may also be formed using a vapor phase growth method such as a sputtering method, CVD method, ALD method, and vapor deposition method described above, and the organic film 7 may also be formed using either one of the liquid phase method and the vapor phase method described above or using a combination of the two methods to form the protective film 9. When the protective film 9 is formed using the above methods, the structure of the polarizing element 10 illustrated in FIG. 2 is obtained.

Lastly, in the scribing step of step S6, the mother substrate 10W is divided (scribed) to have the shape of the polarizing element 10 in FIG. 1, and thus the polarizing elements 10 are produced. Herein, it is desirable that scribing is performed vertically upward with respect to the second region 12, and the polarizing element 10 thus produced by the scribing is covered, up to the outer edge, with the metal film 4. Although scribing using a laser ablation method is desirable in terms of reduction of defects at the time of cutting as well as in terms of improved production yield, the mother substrate 10W may also be scribed using a blade made of metal or the like to produce the polarizing elements 10.

As such, according to Exemplary Embodiment 1, the polarizing element 10 of any size for guaranteeing corrosion resistance can be readily manufactured.

### Exemplary Embodiment 2

### Polarizing Element

Next, a polarizing element of Exemplary Embodiment 2 will be described with reference to FIG. 13. FIG. 13 is a cross-sectional view schematically illustrating a structure of a polarizing element of Exemplary Embodiment 2. In light of the polarizing element 10 of Exemplary Embodiment 1, the method of manufacturing the polarizing element of Exemplary Embodiment 2 is a method of obtaining a polarizing element for guaranteeing corrosion resistance by which the load on the manufacturing process is minimized, in which a natural oxide film on the surface of the grid 2 is grown by heating the polarizing element or the mother substrate in an atmosphere containing oxygen to form an oxide film having enough film thickness. Accordingly, the configurations as in the polarizing element 10 of Exemplary Embodiment 1 are referenced using like numbers, and no detailed descriptions for such configurations are provided below.

As illustrated in FIG. 13, a polarizing element 20 of Exemplary Embodiment 2 basically has the same configuration as the polarizing element 10 of Exemplary Embodiment 1. The polarizing element 20 of Exemplary Embodiment 2 includes a first region 11 provided with a plurality of grids 2 and a second region 12 provided with the metal film 4 in a manner surrounding the first region 11. In the first region 11 and the second region 12, the plurality of grids 2 are formed on one surface of the substrate 1 having light translucency in a manner being aligned at predefined intervals in one direction. In the second region 12, the metal film 4 is formed to cover the plurality of grids 2. In addition to the above configuration, the polarizing element 20 of Exemplary Embodiment 2 includes the dielectric layer 2C formed on the surface of the fine line portion 2A constituting the grid 2, the dielectric layer 2D formed on the surface of the absorption layer 2B overlaid on the top portion of the fine line portion 2A, and a dielectric layer 4A formed on the surface of the metal film 4 in the second region 12.

The dielectric layer 4A formed on the surface of the metal film 4 is an oxide film obtained by growing the natural oxide film of the metal constituting each of the films and covers the grid 2 in addition to the dielectric layer 2C on the surface of the fine line portion 2A and the dielectric layer 2D on the surface of the absorption layer 2B. The dielectric layers 2C and 2D having a thickened film thickness of the natural oxide film, which is capable of increasing the time required until a corrosive substance reaches the metal of the fine line portion 2A or the metal film 4, can increase the time required until the grid 2 or the metal film 4 is corroded.

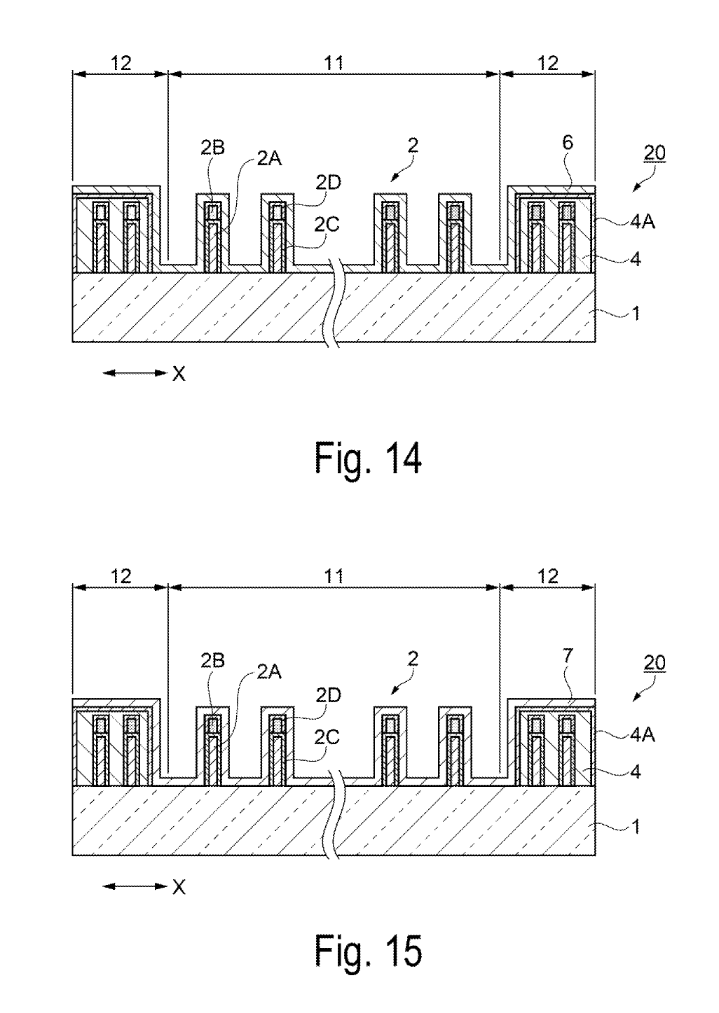

FIG. 14 is a cross-sectional view schematically illustrating a polarizing element in which the inorganic film of Exemplary Embodiment 2 is used alone as a protective film, and FIG. 15 is a cross-sectional view schematically illustrating a polarizing element in which the organic film of Exemplary Embodiment 2 is used alone as a protective film.

After the dielectric layers 2C and 2D as the oxide film obtained by growing the natural oxide film are formed, as illustrated in FIGS. 14 and 15, either one or both of the inorganic film 6 having light translucency and the organic film 7 having water repellency may be formed as the protective film 9 as in Exemplary Embodiment 1 where appropriate.

As such, according to Exemplary Embodiment 2, the polarizing element 20 of any size for guaranteeing corrosion resistance can be readily provided using a method by which the load on the manufacturing process is minimized.

Method of Manufacturing Polarizing Element

The method of manufacturing the polarizing element 20 in Exemplary Embodiment 2 is a method in which an annealing step of heating the mother substrate 10W is performed between the forming of the second metal film in step S4 and the forming of the protective film in step S5 in the flowchart of the method of manufacturing the polarizing element 20 of Exemplary Embodiment 1 illustrated in FIG. 5, where the other processes are performed as in the method of manufacturing Exemplary Embodiment 1.

The annealing step may be performed between the patterning step of step S3 and the forming of the second metal film of step S4 or between the forming of the inorganic film 6 of step S5-1 and the forming of the organic film 7 of step S5-2.

As described above, the dielectric layer 2C is formed of aluminum oxide and the dielectric layer 2D is formed of silicon oxide. These layers, which may be formed by an exposure to the atmosphere, are formed using a method of heating at a temperature of from 100° C. to 500° C. for a certain period of time in an atmosphere containing oxygen in Exemplary Embodiment 2, by which a natural oxide film can be readily grown compared to the case of an exposure to the atmosphere for 24 hours.

As such, according to Exemplary Embodiment 2, the polarizing element 20 of any size for guaranteeing corrosion resistance can be readily manufactured using a method by which the load on the manufacturing process is minimized.

The polarizing element 10 or the polarizing element 20 of the above embodiments, in a case of a transmissive type liquid crystal projector, is installed on the incident side and the exit side of light with a liquid crystal light valve interposed therebetween, where each of the elements is utilized as a polarization plate. Meanwhile, in a case of a reflection type liquid crystal projector, the polarizing element 10 or the polarizing element 20 of the above exemplary embodiments is installed at a position closer to the light source than the liquid crystal light valve, where the elements are each utilized as a polarization plate. In both liquid crystal projectors of the transmission type and the reflection type, the liquid crystal light valve is exposed to intense light for a long period of time. An organic polarization plate that is currently in general use does not have enough resistance to the intense light for a long period of time and thus a brighter projector has been required to be developed, whereas by using the polarizing element 10 or the polarizing element 20, which are wire grid typed, of the above exemplary embodiments, the amount of light emitted from the light source of the liquid crystal projector can further be increased. In addition, the polarizing element 10 or the polarizing element 20 having been improved in corrosion resistance can be stably used for a long period of time even in high temperature and high humidity countries as well as in high humidity environments such as coasts and hot springs. Thus, the liquid crystal projector can adopt to a wider range of environments in application of the liquid crystal projector.

Note that the invention is not limited to the above-described embodiments, and various modifications and improvements may be added to the above-described embodiments. A modified example will be described below.

### MODIFIED EXAMPLE 1

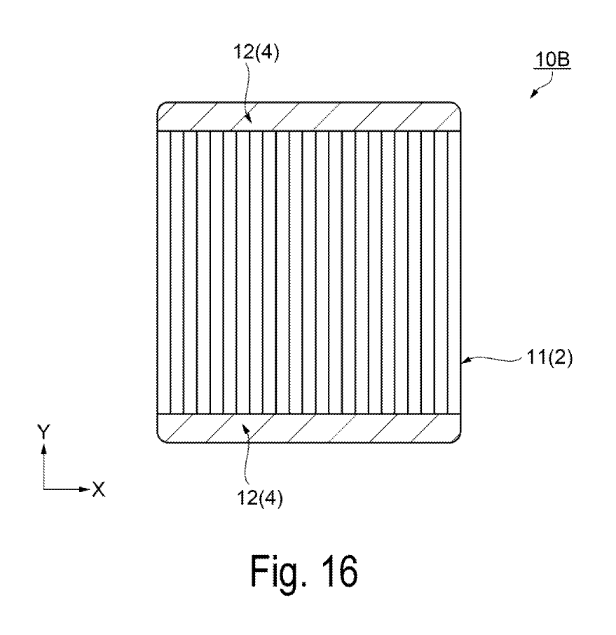

FIG. 16 is a plan view schematically illustrating a configuration of a polarizing element of Modified Example 1. As illustrated in FIG. 16, a polarizing element 10B of Modified Example 1 is located outside the first region 11 in which the metal film 4 is formed in a manner extending along the X direction at both end portions in the Y direction in which the grid 2 extends. The polarizing element 10B has the same configuration as the polarizing element 10 or the polarizing element 20 described above except for the shape of the metal film 4.

The polarizing element 10B employing the above configuration includes a structure for suppressing the progress of corrosion to a minimized level. The corrosion of the grid 2 that normally proceeds in the Y direction along the grid 2 can be suppressed by covering both of the end portions in the Y direction in which the grid 2 extends with the metal film 4.

The shape of the polarizing element 10B makes the structure of the opening 60a of the mask 60 simpler, by which it can be said that the load on the manufacturing process is minimized.

Accordingly, it can be said that the polarizing element 10B to which Modified Example 1 is applied also has a structure for guaranteeing corrosion resistance, by which the load on the manufacturing process is minimized.

The entire disclosure of Japanese Patent Application No. 2017-242456, filed Dec. 19, 2017 is expressly incorporated by reference herein.

What is claimed is:

1. A polarizing element comprising:
a substrate having light translucency;
a grid aligned at predefined intervals in one direction, the grid being formed of metal; and
a metal film that covers the grid formed in a second region along an outer edge of the substrate, the second region being outside of a first region.

2. The polarizing element according to claim 1, including
an oxide film that covers the grid.

3. The polarizing element according to claim 1, wherein
the metal film is provided to fill a gap of the grid in the second region.

4. The polarizing element according to claim 1, wherein
the metal film is formed of a metal having higher ionization tendency than the grid.

5. The polarizing element according to claim 1, including
a protective film that covers the grid in the first region and covers the metal film in the second region.

6. The polarizing element according to claim 5, wherein
the protective film is formed of an inorganic film having light translucency.

7. The polarizing element according to claim 5, wherein
the protective film is formed of an organic film having water repellency.

8. The polarizing element according to claim 5, wherein
the protective film includes an inorganic film having light translucency and
an organic film having water repellency overlaid on the inorganic film.

9. The polarizing element according to claim 1, wherein
the grid includes a fine line portion aligned in the one direction and
an absorption layer having light absorbency provided on a top portion of the fine line portion.
